(19) United States
(12) Patent Application Publication
(10) Pub. No.: US 2026/0054103 A1
(43) Pub. Date: Feb. 26, 2026

(54) MECHANICAL RESTRICTOR-BASED OXYGEN INITIATOR

(71) Applicant: B/E Aerospace, Inc., Winston Salem, NC (US)

(72) Inventors: Mohmad Aejaj Maiyoddin Kadri, Bangalore (IN); Deepak Mohan, Bangalore (IN)

(73) Assignee: B/E Aerospace, Inc., Winston Salem, NC (US)

(21) Appl. No.: 19/251,602

(22) Filed: Jun. 26, 2025

(30) Foreign Application Priority Data
Aug. 21, 2024 (IN) 202441063158

(51) Int. Cl. A62B 9/04; B64D 13/00

(52) U.S. Cl. CPC A62B 9/04; B64D 13/00; B64D 2231/02

(57) ABSTRACT

A manifold assembly is provided. The manifold assembly includes a pressurized gas manifold, a manifold insert, an initiator, and a mechanical restrictor. The manifold insert is mechanically coupled to the pressurized gas manifold. The initiator is mechanically coupled to the manifold insert. The initiator includes a lance and an initiator mechanism. The initiator mechanism is configured to initiate thereby causing the lance to translate the lance to a deployed state and rupture a rupture disc. The mechanical restrictor is configured to securely lock the lance in the deployed state.

### CROSS-REFERENCE TO RELATED APPLICATIONS

This application claims priority to, and the benefit of, India Patent Application No. 202441063158, filed Aug. 21, 2024 (DAS Coded 30BB) and titled “MECHANICAL RESTRICTOR-BASED OXYGEN INITIATOR,” which is incorporated by reference herein in its entirety for all purposes.

### FIELD

The present disclosure generally relates to the field of emergency oxygen systems and, more particularly, to a mechanical restrictor-based oxygen initiator for an emergency oxygen system.

### BACKGROUND

Emergency oxygen systems are found in commercial aircraft. Emergency oxygen systems typically include an oxygen manifold mounted to an oxygen cylinder. The oxygen manifold includes a rupture disc that directly abuts an oxygen cylinder outlet. In typical emergency oxygen systems, responsive to an oxygen flow being requested, an oxygen initiator may include a pyrotechnical charge that may be electrically triggered thereby translating a lance such that an end of the lance punctures or otherwise pierces the rupture disc so that oxygen will flow. In typical emergency oxygen systems, during this process, the lance is held in place by the rupture disc thereby allowing the oxygen to flow.

### SUMMARY

A manifold assembly is disclosed. The manifold assembly includes a pressurized gas manifold, a manifold insert, an initiator, and a mechanical restrictor. The manifold insert is mechanically coupled to the pressurized gas manifold. The initiator is mechanically coupled to the manifold insert. The initiator includes a lance and an initiator mechanism configured to initiate thereby causing the lance to translate the lance to a deployed state and rupture a rupture disc. The mechanical restrictor is configured to securely lock the lance in the deployed state.

In various embodiments, the mechanical restrictor includes a biasing member, a translating member, and a spring. In various embodiments, the spring is positioned between the biasing member and the translating member.

In various embodiments, the lance comprises a recess. In various embodiments, the mechanical restrictor is configured to securely lock the lance in the deployed state by the translating member translating into the recess on the lance.

In various embodiments, the recess on the lance comprises a first shape that coincides with a second shape of a distal end of the translating member.

In various embodiments, the first shape and the second shape are at least one of a wedge, semicircle, or a square.

In various embodiments, the mechanical restrictor is positioned within the manifold insert.

In various embodiments, the mechanical restrictor is positioned within the initiator.

In various embodiments, the initiator mechanism is at least one of a pyrotechnical deployment mechanism or a solenoid-based actuation mechanism.

Also disclosed is a passenger service unit. The passenger service unit includes a regulator, a pressurized oxygen container including a pressurized oxygen container outlet, and a manifold assembly. The manifold assembly includes a pressurized gas manifold, a manifold insert, an initiator, and a mechanical restrictor. The manifold insert is mechanically coupled to the pressurized gas manifold. The initiator is mechanically coupled to the manifold insert. The initiator includes a lance and an initiator mechanism configured to initiate thereby causing the lance to translate the lance to a deployed state and rupture a rupture disc. The mechanical restrictor is configured to securely lock the lance in the deployed state. The regulator is mechanically coupled to the pressurized gas manifold via a regulator connector, The pressurized oxygen container is mechanically coupled to the pressurized gas manifold via the pressurized oxygen container outlet.

In various embodiments, the mechanical restrictor includes a biasing member, a translating member, and a spring. In various embodiments, the spring is positioned between the biasing member and the translating member.

In various embodiments, the lance comprises a recess. In various embodiments, the mechanical restrictor is configured to securely lock the lance in the deployed state by the translating member translating into the recess on the lance.

In various embodiments, the recess on the lance comprises a first shape that coincides with a second shape of a distal end of the translating member.

In various embodiments, the first shape and the second shape are at least one of a wedge, semicircle, or a square.

In various embodiments, the mechanical restrictor is positioned within the manifold insert.

In various embodiments, the mechanical restrictor is positioned within the initiator.

In various embodiments, the initiator mechanism is at least one of a pyrotechnical deployment mechanism or a solenoid-based actuation mechanism.

Also disclosed is an aircraft. The aircraft includes a passenger service unit. The passenger service unit includes a regulator, a pressurized oxygen container including a pressurized oxygen container outlet, and a manifold assembly. The manifold assembly includes a pressurized gas manifold, a manifold insert, an initiator, and a mechanical restrictor. The manifold insert is mechanically coupled to the pressurized gas manifold. The initiator is mechanically coupled to the manifold insert. The initiator includes a lance and an initiator mechanism configured to initiate thereby causing the lance to translate the lance to a deployed state and rupture a rupture disc. The mechanical restrictor is configured to securely lock the lance in the deployed state. The regulator is mechanically coupled to the pressurized gas manifold via a regulator connector, The pressurized oxygen container is mechanically coupled to the pressurized gas manifold via the pressurized oxygen container outlet.

In various embodiments, the mechanical restrictor includes a biasing member, a translating member, and a spring. In various embodiments, the spring is positioned between the biasing member and the translating member.

In various embodiments, the lance comprises a recess. In various embodiments, the mechanical restrictor is configured to securely lock the lance in the deployed state by the translating member translating into the recess on the lance.

In various embodiments, the recess on the lance comprises a first shape that coincides with a second shape of a distal end of the translating member. In various embodiments, the first shape and the second shape are at least one of a wedge, semicircle, or a square.

The present disclosure may include any one or more of the individual features disclosed above and/or below alone or in any combination thereof. The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates an emergency oxygen system including a manifold assembly, in accordance with various embodiments.

FIG. 2 illustrates another view of the emergency oxygen system including a manifold assembly, in accordance with various embodiments.

FIG. 3 illustrates a view of a manifold assembly coupled to a pressurized oxygen container, in accordance with various embodiments.

FIG. 4 illustrates a top cross-sectional view of the manifold assembly coupled to a pressurized oxygen container, in accordance with various embodiments.

FIG. 5 illustrates a side cross-sectional view of the manifold assembly coupled to a pressurized oxygen container, in accordance with various embodiments.

FIG. 6 illustrates a cross-sectional view of the manifold assembly before a lance has punctured a rupture disc, in accordance with various embodiments.

FIG. 7 illustrates a cross-sectional view of the manifold assembly after a lance has punctured a rupture disc, in accordance with various embodiments.

FIGS. 8A and 8B illustrate a mechanical restrictor-based oxygen initiator for an emergency oxygen system, in accordance with various embodiments.

FIGS. 9A, 9B, and 9C, illustrate various shapes of a translating member of a mechanical restrictor of a mechanical restrictor-based oxygen initiator of an emergency oxygen system, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

As stated previously, typical emergency oxygen systems include an oxygen manifold mounted to an oxygen cylinder. The oxygen manifold includes a rupture disc that directly abuts an oxygen cylinder outlet. In typical emergency oxygen systems, responsive to an oxygen flow being requested, an oxygen initiator may include an initiator mechanism that may be electrically triggered thereby translating a lance such that an end of the lance punctures or otherwise pierces the rupture disc so that oxygen will flow. In typical emergency oxygen system systems, during this process, the lance is held in place by the rupture disc thereby allowing the oxygen to flow. However, in such typical emergency oxygen systems, the oxygen initiator may experience oxygen leakage issues, characterized by the lance retracting slightly from its intended hold position, leading to, for example, unintended loss of oxygen or reduced oxygen flow to a mask utilized by a passenger of crew member. That is, typically, once the lance punctures or otherwise pierces the rupture disc so that oxygen will flow, the lance is held in place by a seal, such as a silicon O-ring. When using O-rings to hold a lance, friction is a key factor. The O-ring creates a seal by being slightly compressed around an outer circumference of the lance. This compression generates friction, which helps hold the lance in place. However, in an event where the seal is not uniformly compressed around an outer circumference of the lance, this friction may be inconsistent due to variations in compression, wear, or environmental conditions, among others, which may allow the lance to retract slightly from its intended hold position, leading to, for example, unintended loss of oxygen or reduced oxygen flow to a mask utilized by a passenger of crew member.

Disclosed herein are systems and methods for a mechanical restrictor-based oxygen initiator for an emergency oxygen system. In various embodiments, the mechanical restrictor secures the lance in a desired position following the triggering of lance and rupture of the disc. In various embodiments, the mechanical restrictor is configured to be integrated into a chamber of the initiator surrounding the lance. In various embodiments, the mechanical restrictor is configured to be integrated into a portion of a manifold insert. In various embodiments, the mechanical restrictor is configured with a biasing member, a spring, and a translating member. In various embodiments, the lance is configured with a void or recess in which the translating member of the mechanical restrictor is configured to translate into. In various embodiments, responsive to the mechanical restrictor-based oxygen initiator being in an undeployed state, the translating member of the mechanical restrictor is configured to slide along a position of the outer circumference of the lance. In various embodiments, responsive to an oxygen flow being requested and the initiator mechanism being triggered and translating the lance such that an end of the lance punctures or otherwise pierces the rupture disc so that oxygen will flow, a void or recess of the lance translates so as to align with the mechanical restrictor and the translating member of the mechanical restrictor translates, due to a spring force of the spring being biased against the biasing member, into a void or recess thereby securely locking the lance in a deployed state. In various embodiments, the initiator mechanism is at least one of a pyrotechnical deployment mechanism or a solenoid-based actuation mechanism, among others. In various embodiments, a distal end of the translating member of the mechanical restrictor may be wedge-shaped, square-shaped, or semi-circular shaped, among others. In that regard, the associated void in the lance may be wedge-shaped, square-shaped, or semi-circular shaped, among others.

Broadly, in various embodiments, the concepts disclosed herein are directed to a manifold (e.g., a pressurized gas manifold) and an emergency oxygen system. Accordingly, the various embodiments, the emergency oxygen system may be configured to compactly contain and a discharge compressed matter (e.g., a compressed gas and/or liquid) via a manifold fitted to a pressurized source (e.g., a pressurized gas container, such as a pressurized oxygen container). In various embodiments, the emergency oxygen system may include a manifold assembly and the high-pressure source. In various embodiments, the manifold assembly may include the manifold, a manifold insert, a rupture disc, a regulator, and various seals. In various embodiments, the manifold may be mechanically coupled to the pressurized source through a leak-free interface. In various embodiments, the manifold may include a high-pressure side and a low-pressure side, which are separated by a rupture disc. In various embodiments, the rupture disc may be seated near the manifold insert to also be leak-free. In various embodiments, the manifold may be configured to allow for an outlet port (e.g., an outlet port for a regulator) to be implemented at any angle relative to an outlet port of the high-pressure source (e.g., a pressurized gas container outlet, such as a pressurized oxygen container outlet).

In various embodiments, the pressurized gas container and manifold assembly may be mounted in a vehicle (e.g., an aircraft), such as in a passenger service unit (PSU) or in a vicinity of a galley or lavatory installation. For example, in various embodiments, the pressurized gas container may serve between one and five users in each seating group or location.

In various embodiments, the manifold may incorporate a rupture disc and provide a means for filling the pressurized gas container with a gas (e.g., a breathing gaseous mixture include oxygen) via a dedicated fill port. In various embodiments, the manifold may be a single use device that may be connected to an initiator and a pressure regulator. In various embodiments, the manifold may include a plurality of seals. For example, in various embodiments, with the exception of the rupture disc and a pressurized gas container to manifold seal, some or all the seals of the manifold interfaces may be silicon O-rings.

In various embodiments, a geometry of the manifold assembly may be configured so that the manifold assembly can fit into a compact space, such as inside of a PSU. In various embodiments, a regulator hose and initiator wire may be positioned in any relative direction provided they are downstream of the rupture disc. In various embodiments, such flexibility in design allows the initiator lead wire and regulator hose to be directed in a most efficient manner to reduce length, limit hose and wire bending, and simplify installation for a technician.

In various embodiments, the manifold assembly includes a rupture disc seal that is separated from the fill port. In various embodiments, this allows the rupture disc seal of the manifold to be leak tested prior to installation of the manifold assembly and filling of the pressurized gas container. In various embodiments, this reduces repair repetition time if a leak is found within the rupture disc seal.

As compared to existing manifolds, in various embodiments, the rupture disc may have a diameter smaller than a diameter of the pressurized gas container outlet to allow for a decreased size in the manifold while allowing for the same effective burst area and rupture pressures.

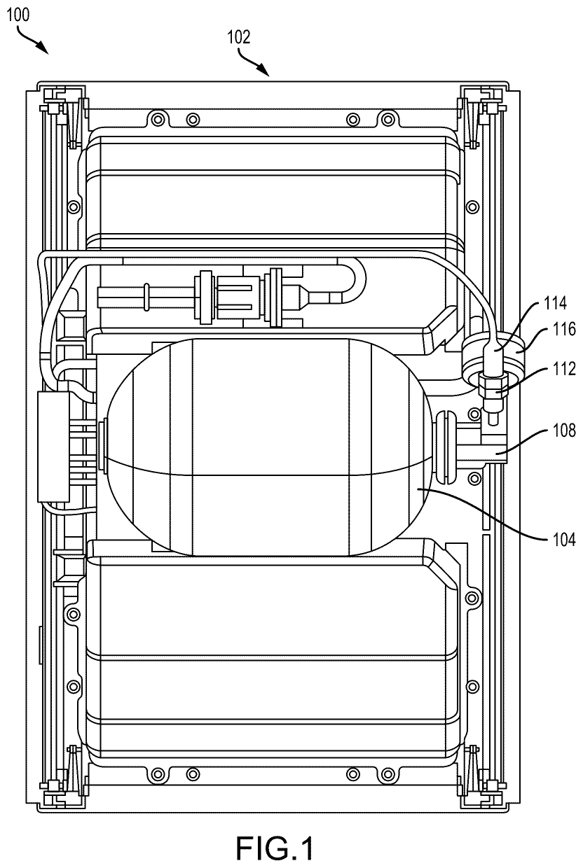

Referring now to FIG. 1, in accordance with various embodiments, an emergency oxygen system including a manifold assembly is illustrated. In various embodiments, the emergency oxygen system may be any suitable system, such as a vehicular system (e.g., an aircraft system) of a vehicle (e.g., an aircraft 100). In various embodiments, the emergency oxygen system may be implemented as or include a PSU 102 of the aircraft 100. In that regard, in various embodiments, the emergency oxygen system may be configured to provide oxygen to passengers of the aircraft 100. In various embodiments, the emergency oxygen system may include a regulator 116 (e.g., a pressure regulator), a manifold insert 112, an initiator 114 mechanically coupled to the manifold insert 112, a pressurized source (e.g., a pressurized gas container (e.g., a pressurized oxygen container 104)), and a manifold 108 (e.g., a pressurized gas manifold). The regulator 116, the manifold insert 112, the initiator 114, the pressurized oxygen container 104, and the manifold 108 may be installed in the aircraft 100, such as in the PSU 102, in a lavatory, or in a galley.

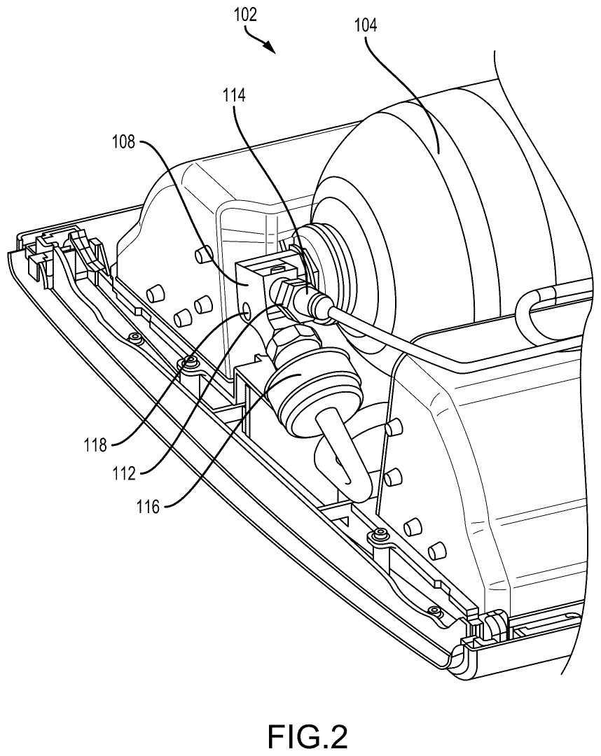

Referring now to FIG. 2, in accordance with various embodiments, another view of the emergency oxygen system including a manifold assembly is illustrated. As described with respect to FIG. 1, in various embodiments, the emergency oxygen system illustrated in FIG. 2 may be implemented as or include a PSU 102 of the aircraft 100. In that regard, in various embodiments, the emergency oxygen system may include the regulator 116 (e.g., a pressure regulator), the manifold insert 112, the initiator 114 mechanically coupled to the manifold insert 112, a pressurized source (e.g., a pressurized gas container (e.g., a pressurized oxygen container 104)), and a manifold 108 (e.g., a pressurized gas manifold). The regulator 116, the manifold insert 112, the initiator 114, the pressurized oxygen container 104, and the manifold 108 may be installed in the aircraft 100, such as in the PSU 102, in a lavatory, or in a galley. In difference to FIG. 1, in various embodiments, the body of the manifold 108 may further include a sealable fill port 118 with a pathway through the manifold 108 such that the pressurized oxygen container 104 may be filled. In various embodiments, the sealable fill port 118 may be separated from a hollow pathway network of the manifold 108, described hereafter.

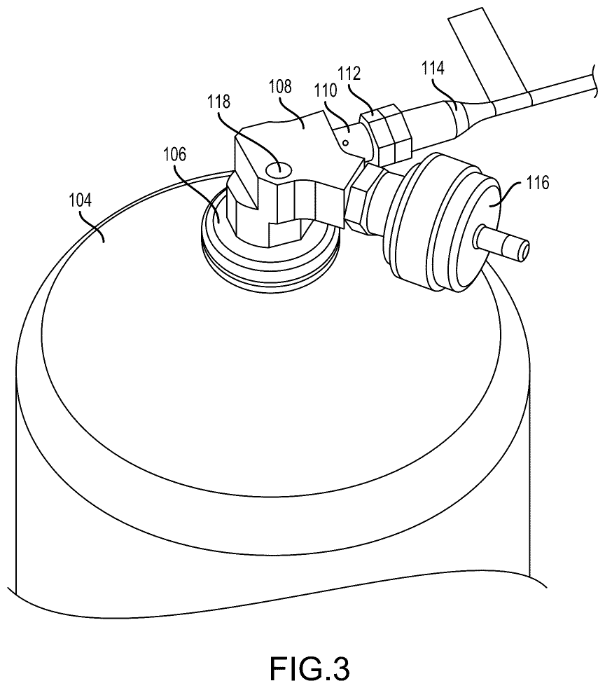

Referring now to FIG. 3, in accordance with various embodiments, a view of a manifold assembly coupled to a pressurized oxygen container is illustrated. In various embodiments, the manifold assembly may include the regulator 116, the manifold insert 112, the initiator 114 mechanically coupled to the manifold insert 112, and the manifold 108 mechanically coupled the pressurized oxygen container 104. In various embodiments, the manifold insert 112 may include at least one discharge indicator 110 configured to provide a visual indication of an overpressure event. In various embodiments, the at least one discharge indicator 110 may be fitted over one or more (e.g., one, two, three, or four) discharge ports, described hereafter. In various embodiments, the discharge indicator(s) 110 may be implemented as a frangible vinyl label(s) with an adhesive backing(s) located over the discharge port(s) to provide indication. In various embodiments, the manifold assembly may be mechanically coupled to the pressurized oxygen container 104 via a coupling that includes a grommet 106. As discussed in FIG. 2, the body of the manifold 108 may further include a sealable fill port 118 with a pathway through the manifold 108 such that the pressurized oxygen container 104 may be filled. In various embodiments, the sealable fill port 118 may be separated from a hollow pathway network of the manifold 108, described hereafter.

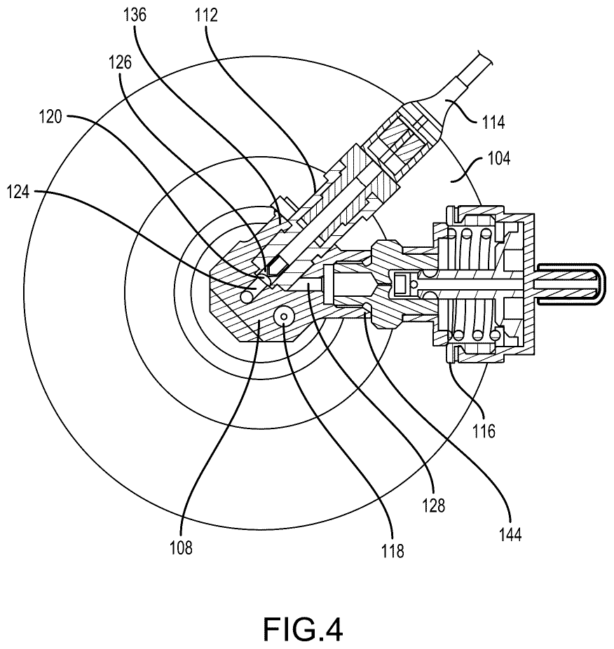

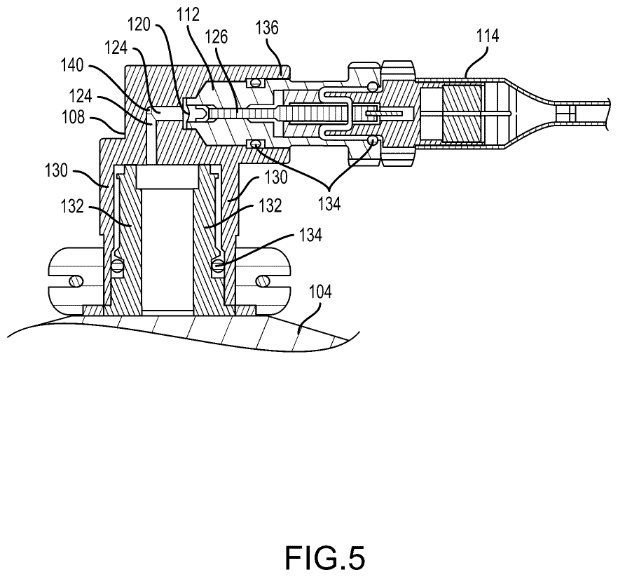

Referring now to FIGS. 4 and 5, in accordance with various embodiments, a top cross-sectional view and a side cross-sectional view, respectively, of the manifold assembly coupled to a pressurized oxygen container is illustrated. In various embodiments, the manifold assembly may include the regulator 116, the manifold insert 112, the initiator 114 mechanically coupled to the manifold insert 112, and the manifold 108 mechanically coupled the pressurized oxygen container 104. In various embodiments, the body of the manifold 108 may further include a hollow pathway network implemented within the body. In various embodiments, the hollow pathway network may include a first path portion 124, a second path portion 126, and a third path portion 128. In various embodiments, the first path portion 124 may extend from a first opening positioned to receive oxygen from the pressurized oxygen container outlet 132 and extend to a pathway junction where the first path portion 124, the second path portion 126, and the third path portion 128 converge.

In various embodiments, the first path portion 124 may include a bend 140. The bend 140 may have any suitable angle (e.g., between 10 and 170 degrees, between 30 and 150 degrees, between 45 and 135 degrees, between 60 and 120 degrees, or approximately 90 degrees (+/−10 degrees)). The second path portion 126 may extend from the pathway junction to a second opening positioned in the female manifold insert connector 136. The third path portion 128 may extend from the pathway junction to a third opening positioned in the regulator connector 144. In various embodiments, the second path portion 126 and the third path portion 128 are coplanar. For example, the second path portion 126 and the third path portion 128 may be oriented in plane at any angle relative to a section of the first path portion 124 between the first opening and the bend 140. For example, the second path portion 126 and the third path portion 128 may be oriented approximately orthogonal to a section of the first path portion 124 between the first opening and the bend 140. The second path portion 126 may be offset by any suitable angle from the third path portion 128. For example, the second path portion 126 may be offset by between 20 and 160 degrees (e.g., approximately 45 degrees (+/−10 degrees)) from the third path portion 128.

In that regard, in various embodiments, the manifold 108 may include a body. In various embodiments, the body may be composed of any suitable material, such as a copper alloy. In various embodiments, the body of the manifold 108 may include a first connector (e.g., a female connector 130) connected to the pressurized oxygen container 104. In various embodiments, the body may further include a second connector (e.g., a female manifold insert connector 136) connected to the manifold insert 112. In various embodiments, the body may further include a third connector (e.g., a regulator connector 144) connected to the regulator 116. In various embodiments, while the connectors 130, 136, and 144 are exemplarily depicted and described as female connectors, in various embodiments, the connectors 130, 136, and 144 may be implemented as male connectors, female connectors, other types of connectors, or some combination thereof. As such, in various embodiments, the each of the female connector 130, the female manifold insert connector 136, and the regulator connector 144 may be implemented with any angular orientation relative to the other connectors.

In various embodiments, a rupture disc 120 may be seated in the manifold 108. In various embodiments, the rupture disc 120 may be composed of any suitable material, such as nickel, a nickel alloy, copper, and/or a copper alloy. In various embodiments, the rupture disc 120 may be positioned between the bend 140 of the first path portion 124 and the pathway junction. In various embodiments, the rupture disc 120 may be oriented perpendicular to a longitudinal direction of the second path portion 126 such that a lance 142 may move through the second path portion 126 to pierce the rupture disc 120 when initiated. In various embodiments, responsive to the rupture disc 120 being in an unruptured state, the rupture disc 120 may be configured to seal the first path portion 124 from the second path portion 126 and the third path portion 128. In various embodiments, responsive to the rupture disc 120 being in a ruptured state (e.g., pierced by the lance 142), the rupture disc 120 may be configured to allow a flow of oxygen from the pressurized oxygen container outlet 132 to the regulator 116. In various embodiments, a diameter of the rupture disc 120 may be less than a diameter of the pressurized oxygen container outlet 132.

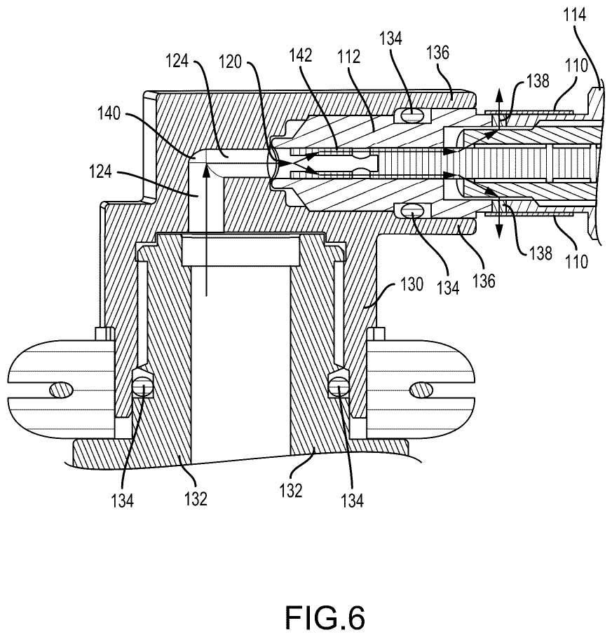

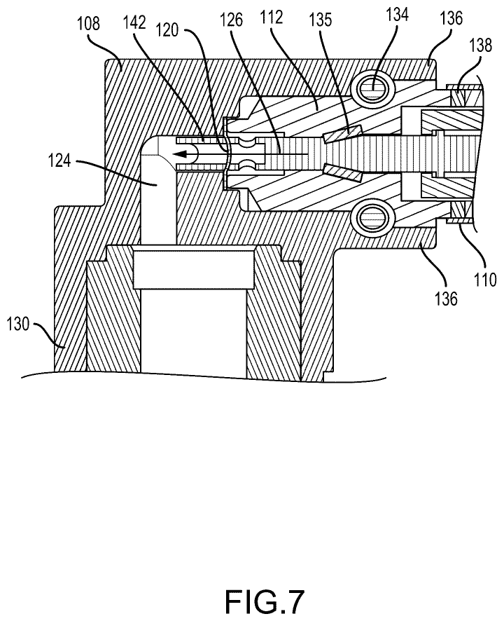

Referring now to FIGS. 6 and 7, in accordance with various embodiments, cross-sectional views of the manifold assembly prior to and after, respectively, the lance has punctured the rupture disc is illustrated. FIGS. 6 and 7 as illustrated include similar components to those illustrated in FIGS. 4 and 5. In that regard, components not specifically discussed in relation to FIGS. 6 and 7 operate in a same manner as discussed in FIGS. 4 and 5. Accordingly, in various embodiments, the manifold insert 112 may be connected to the female manifold insert connector 136 and the initiator 114. In various embodiments, the manifold insert 112 may at least partially longitudinally reside within the second path portion 126. In an unruptured state, in various embodiments, the manifold insert 112 may be configured to compressibly seal the rupture disc 120 against the body of the manifold 108 to maintain a pressure differential from the pressurized first path portion 124 and the unpressurized second path portion 126 and third path portion 128 of FIG. 4. In various embodiments, in the event of an overpressure discharge from the rupture disc 120, the high-pressure gas may be directed around lance 142 through at least one discharge port 138 of the manifold insert 112.

In various embodiments, the initiator 114 may be connected to the manifold insert 112. In various embodiments, the initiator 114 may be electrically triggered to initiate an initiator mechanism, such as a pyrotechnic charge or a solenoid-based actuator, among others, to cause the lance 142 to pierce and rupture the rupture disc 120, thus allowing a flow of oxygen from the pressurized oxygen container outlet 132 to the regulator 116 through the third path portion 128. The lance 142 may be positioned and extend longitudinally, at least in part, within the manifold insert 112 and within the second path portion 126. In various embodiments, responsive to the rupture disc 120 being in a ruptured state, the lance 142 may engage with at least one seal 135 (e.g., a silicon O-ring) within the manifold insert 112 to seal oxygen from passing through the manifold insert 112 around the lance 142. In that regard, in various embodiments, the at least one seal 135 (e.g., a silicon O-ring) may be positioned between the manifold 108 and the manifold insert 112 to prevent leakage of gas around the manifold insert 112 when the rupture disc 120 is in a ruptured state.

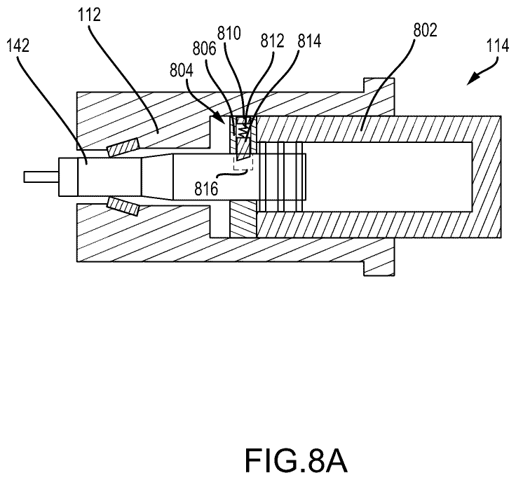

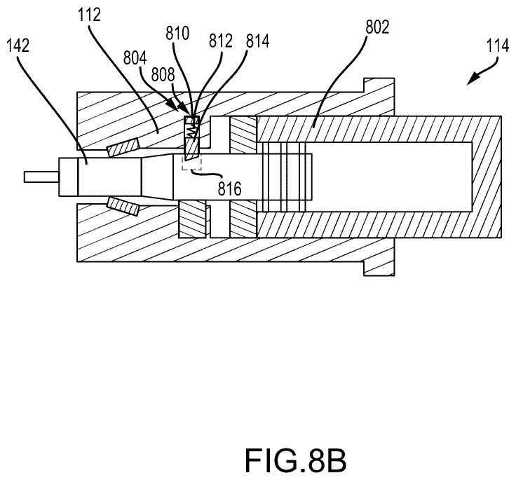

Referring now to FIGS. 8A and 8B, in accordance with various embodiments, a mechanical restrictor-based oxygen initiator for an emergency oxygen system is illustrated. In various embodiments, the initiator 114, which is coupled to the manifold insert 112, includes the lance 142 that is positioned within a chamber 802. In various embodiments, responsive to the initiator 114 being triggered, i.e. electrically triggered to initiate an initiator mechanism, such as a pyrotechnic charge or a solenoid-based actuator, among others, that causes the lance 142 to translate out the chamber 802 and toward the rupture disc, such as rupture disc 120 of FIGS. 6 and 7. In various embodiments, in order to restrict the lance 142 from retracting once the rupture disc 120 has been ruptured and thus, leading to, for example, an unintended loss of oxygen or reduced oxygen flow, the initiator 114 further includes a mechanical restrictor 804 that secures the lance 142 in a desired position following the triggering of lance 142 and rupture of the rupture disc. While FIGS. 8A and 8B illustrate only one mechanical restrictor 804, in the various embodiments, there may be more than one mechanical restrictor 804 configured to secure the lance 142 in a desired position following the triggering of lance 142 and rupture of the rupture disc. In that regard, there may be more than one mechanical restriction on either side of the land at either one or both locations illustrated in FIGS. 8A and 8B. In various embodiments, as is illustrated in FIG. 8A, the mechanical restrictor 804 is configured to be integrated into an end portion 806 of the chamber 802 surrounding the lance 142. In various embodiments, as is illustrated in FIG. 8B, the mechanical restrictor 804 is configured to be integrated into a portion 808 of the manifold insert 112.

In either location, in various embodiments, the mechanical restrictor 804 is configured with a biasing member 810, a spring 812, and a translating member 814. In various embodiments, the lance is configured with a void or recess 816 in which the translating member 814 of the mechanical restrictor 804 is configured to translate into. In various embodiments, responsive to the lance 142 being in an undeployed state, the translating member 814 of the mechanical restrictor 804 is configured to slide along a position of the outer circumference of the lance 142. In various embodiments, responsive to an oxygen flow being requested and the initiator mechanism being triggered and translating the lance 142 such that an end of the lance 142 punctures or otherwise pierces the rupture disc so that oxygen will flow, a void or recess 816 of the lance 142 translates so as to align with the mechanical restrictor 804 and the translating member 814 of the mechanical restrictor 804 translates, due to a spring force of the spring 812 being biased against the biasing member 810, into the void or recess 816 thereby securely locking the lance 142 in a deployed state.

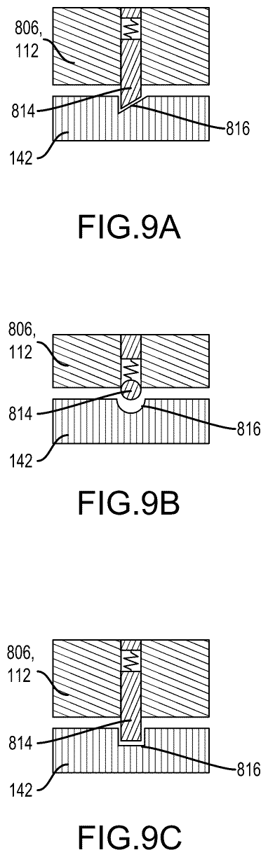

Referring now to FIGS. 9A, 9B, and 9C, in accordance with various embodiments, various shapes of a translating member of a mechanical restrictor of a mechanical restrictor-based oxygen initiator of an emergency oxygen system is illustrated. In various embodiments, as is illustrated in FIG. 9A, a distal end of the translating member 814, i.e. the portion of the translating member 814 that translates into the void or recess 816 of the lance 142, is configured to be wedge-shaped. Accordingly, the void or recess 816 in the lance 142 is configured to be wedge-shaped so as to receive the wedge-shaped distal end of the translating member 814. In various embodiments, as is illustrated in FIG. 9B, a distal end of the translating member 814, i.e. the portion of the translating member 814 that translates into the void or recess 816 of the lance 142, is configured to be semi-circular shaped. Accordingly, the void or recess 816 in the lance 142 is configured to be semi-circular shaped so as to receive the semi-circular shaped distal end of the translating member 814. In various embodiments, as is illustrated in FIG. 9c, a distal end of the translating member 814, i.e. the portion of the translating member 814 that translates into the void or recess 816 of the lance 142, is configured to be square-shaped. Accordingly, the void or recess 816 in the lance 142 is configured to be square-shaped so as to receive the square-shaped distal end of the translating member 814.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S. C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A manifold assembly, comprising:
a pressurized gas manifold;
a manifold insert, the manifold insert mechanically coupled to the pressurized gas manifold;
an initiator, the initiator mechanically coupled to the manifold insert, wherein the initiator comprises:
a lance; and
an initiator mechanism configured to initiate thereby causing the lance to translate the lance to a deployed state and rupture a rupture disc; and
a mechanical restrictor, the mechanical restrictor configured to securely lock the lance in the deployed state.

2. The manifold assembly of claim 1, wherein the mechanical restrictor comprises:
a biasing member;
a translating member; and
a spring, wherein the spring is positioned between the biasing member and the translating member.

3. The manifold assembly of claim 2, wherein the lance comprises a recess and wherein the mechanical restrictor is configured to securely lock the lance in the deployed state by the translating member translating into the recess on the lance.

4. The manifold assembly of claim 3, wherein the recess on the lance comprises a first shape that coincides with a second shape of a distal end of the translating member.

5. The manifold assembly of claim 4, wherein the first shape and the second shape are at least one of a wedge, semicircle, or a square.

6. The manifold assembly of claim 1, wherein the mechanical restrictor is positioned within the manifold insert.

7. The manifold assembly of claim 1, wherein the mechanical restrictor is positioned within the initiator.

8. The manifold assembly of claim 1, wherein the initiator mechanism is at least one of a pyrotechnical deployment mechanism or a solenoid-based actuation mechanism.

9. A passenger service unit, comprising:
a regulator;
a pressurized oxygen container including a pressurized oxygen container outlet; and
a manifold assembly, the manifold assembly comprising:
a pressurized gas manifold;
a manifold insert, the manifold insert mechanically coupled to the pressurized gas manifold;
an initiator, the initiator mechanically coupled to the manifold insert, wherein the initiator comprises:
a lance; and
an initiator mechanism configured to initiate thereby causing the lance to translate the lance to a deployed state and rupture a rupture disc; and
a mechanical restrictor, the mechanical restrictor configured to securely lock the lance in the deployed state, wherein the regulator is mechanically coupled to the pressurized gas manifold via a regulator connector and wherein the pressurized oxygen container is mechanically coupled to the pressurized gas manifold via the pressurized oxygen container outlet.

10. The passenger service unit of claim 9, wherein the mechanical restrictor comprises:
a biasing member;
a translating member; and
a spring, wherein the spring is positioned between the biasing member and the translating member.

11. The passenger service unit of claim 10, wherein the lance comprises a recess and wherein the mechanical restrictor is configured to securely lock the lance in the deployed state by the translating member translating into the recess on the lance.

12. The passenger service unit of claim 11, wherein the recess on the lance comprises a first shape that coincides with a second shape of a distal end of the translating member.

13. The passenger service unit of claim 12, wherein the first shape and the second shape are at least one of a wedge, semicircle, or a square.

14. The passenger service unit of claim 9, wherein the mechanical restrictor is positioned within the manifold insert.

15. The passenger service unit of claim 9, wherein the mechanical restrictor is positioned within the initiator.

16. The passenger service unit of claim 9, wherein the initiator mechanism is at least one of a pyrotechnical deployment mechanism or a solenoid-based actuation mechanism.

17. An aircraft, comprising:
a passenger service unit, the passenger service unit comprising:
a regulator;
a pressurized oxygen container including a pressurized oxygen container outlet; and
a manifold assembly, the manifold assembly comprising:
a pressurized gas manifold;
a manifold insert, the manifold insert mechanically coupled to the pressurized gas manifold;
an initiator, the initiator mechanically coupled to the manifold insert, wherein the initiator comprises:
a lance; and
an initiator mechanism configured to initiate thereby causing the lance to translate the lance to a deployed state and rupture a rupture disc; and
a mechanical restrictor, the mechanical restrictor configured to securely lock the lance in the deployed state, wherein the regulator is mechanically coupled to the pressurized gas manifold via a regulator connector and wherein the pressurized oxygen container is mechanically coupled to the pressurized gas manifold via the pressurized oxygen container outlet.

18. The aircraft of claim 17, wherein the mechanical restrictor comprises:
a biasing member;
a translating member; and
a spring, wherein the spring is positioned between the biasing member and the translating member.

19. The aircraft of claim 18, wherein the lance comprises a recess and wherein the mechanical restrictor is configured to securely lock the lance in the deployed state by the translating member translating into the recess on the lance.

20. The aircraft of claim 19, wherein the recess on the lance comprises a first shape that coincides with a second shape of a distal end of the translating member and wherein the first shape and the second shape are at least one of a wedge, semicircle, or a square.
